(19) United States
(12) Patent Application Publication
(10) Pub. No.: US 2025/0106445 A1
(43) Pub. Date: Mar. 27, 2025

(54) MULTI-CASTING SYSTEM AND METHOD FOR INTERACTIVE LIVE-STREAM PROJECTION

(71) Applicant: HCL Technologies Limited, New Delhi (IN)

(72) Inventor: Arun Janarthanan, Chennai (IN)

(21) Appl. No.: 18/665,587

(22) Filed: May 16, 2024

(30) Foreign Application Priority Data
Sep. 27, 2023 (IN) 202311064992

(51) Int. Cl. H04N 21/2187; H04N 21/6405

(52) U.S. Cl. CPC H04N 21/2187; H04N 21/6405

(57) ABSTRACT

This disclosure relates to a multi-casting system and a method for interactive live-stream projection via the multi-casting system. The method includes establishing a wireless connection between a receiving device and a plurality of sending devices. The method further includes rendering at least one option corresponding to each of the plurality of sending devices on a user interface (UI) of the receiving device. The method further includes receiving a user input from a user of the receiving device. It should be noted that receiving the user input includes selecting a first option corresponding to a first sending device from the at least one option corresponding to each of the plurality of sending devices. The method further includes transmitting a live-stream data of the first sending device to the receiving device based on the user input.

### TECHNICAL FIELD

This disclosure relates generally to live-stream projection and more particularly to method and system for interactive live-stream projection via a multi-casting system.

### BACKGROUND

As internet infrastructure improved, a concept of multi-casting gained traction. Multi-casting enables efficient distribution of content to multiple recipients simultaneously. In a context of live-stream projection, this technology is particularly valuable for delivering live events, sports, and news broadcasts to a broad audience. Internet Protocol Television (IPTV) emerged as a prominent application of multi-casting, enabling a delivery of television content over IP networks. Further, Miracast technology emerged as a wireless solution for screen mirroring and content projection.

Miracast dongles have provided a cost-effective and a convenient solution for screen mirroring from mobile devices to larger displays. The Miracst dongles enable users to connect their device (such as smartphones or tablets) to a TV or monitor (a large screen device) wirelessly, allowing for the projection of content, presentations, videos, and more. Further, use of an “Ezmira” app, available for both Android and iOS, enhances the mirroring experience by making it accessible across different platforms without needing an internet connection. However, despite their advantages, the Miracast dongles have limitations that can pose challenges, especially in educational or collaborative settings. One of primary limitations of the Miracast dongles is that when a user is mirroring their screen, only one device is visible on a large display. This limitation can be problematic in educational or collaborative environments where multiple participants need to share their screens or demonstrate their work. As a result, others may not have an opportunity to follow along, participate actively, or engage fully in the session.

Further, the Miracast dongles are primarily designed for screen mirroring, which means that interactivity between the mirrored content and the larger display is limited. This can be a drawback in scenarios where real-time collaboration, interactive presentations, or active engagement with the displayed content are crucial. Additionally, on a larger display, the screen space available for mirroring a mobile device may not be optimized for educational or presentation purposes. This limitation can affect clarity and readability of content, particularly when multiple users are trying to display their screens simultaneously. Moreover, in situations where multiple users are using the Miracast dongles simultaneously, there can be competition for control of the larger display. This may lead to disruptions, conflicts, or delays as users attempt to gain control over the shared screen. In short, the Miracast dongles offer a convenient way to mirror mobile device screens on larger displays, but they have limitations when it comes to multi-user interaction, collaborative learning, and optimizing the educational or collaborative experience.

The present invention is directed to overcome one or more limitations stated above or any other limitations associated with the known arts.

### SUMMARY

In one embodiment, a method for interactive live-stream projection via a multi-casting system is disclosed. In one example, the method may include establishing a wireless connection between a receiving device and a plurality of sending devices. The method may further include rendering at least one option corresponding to each of the plurality of sending devices on a user interface (UI) of the receiving device, upon establishing the wireless connection. The method may further include receiving a user input from a user of the receiving device, in response to rendering. It should be noted that receiving the user input may include selecting a first option corresponding to a first sending device from the at least one option corresponding to each of the plurality of sending devices. The method may further include transmitting a live-stream data of the first sending device to the receiving device based on the user input.

In another embodiment, a multi-casting system for interactive live-stream projection is disclosed. In one example, the system may include a processor and a memory communicatively coupled to the processor. The memory may store processor-executable instructions, which, on execution, may cause the processor to establish a wireless connection between a receiving device and a plurality of sending devices. The processor-executable instructions, on execution, may further cause the processor to render at least one option corresponding to each of the plurality of sending devices on a user interface (UI) of the receiving device, upon establishing the wireless connection. The processor-executable instructions, on execution, may further cause the processor to receive a user input from a user of the receiving device, in response to rendering. It should be noted that receiving the user input may include selecting a first option corresponding to a first sending device from the at least one option corresponding to each of the plurality of sending devices. The processor-executable instructions, on execution, may further cause the processor to transmit a live-stream data of the first sending device to the receiving device based on the user input.

In yet another embodiment, a non-transitory computer-readable medium storing computer-executable instructions for interactive live-stream projection via a multi-casting system is disclosed. In one example, the stored instructions, when executed by a processor, may cause the processor to perform operations including establishing a wireless connection between a receiving device and a plurality of sending devices. The operations may further include rendering at least one option corresponding to each of the plurality of sending devices on a user interface (UI) of the receiving device, upon establishing the wireless connection. The operations may further include receiving a user input from a user of the receiving device, in response to rendering. It should be noted that receiving the user input may include selecting a first option corresponding to a first sending device from the at least one option corresponding to each of the plurality of sending devices. The operations may further include transmitting a live-stream data of the first sending device to the receiving device based on the user input.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for interactive live-stream projection, in accordance with some embodiments of the present disclosure.

FIG. 2 illustrates a functional block diagram of various modules within a memory of a multi-casting system configured for interactive live-stream projection, in accordance with some embodiments.

FIG. 3 illustrates a flow diagram of an exemplary process for interactive live-stream projection via a multi-casting system, in accordance with some embodiments of the present disclosure.

FIG. 4 illustrates a flow diagram of an exemplary process for switching between two sending devices, in accordance with some embodiments of the present disclosure.

FIG. 5 illustrates an exemplary scenario of the interactive live-stream projection via a multi-casting system, in accordance with an exemplary embodiment of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

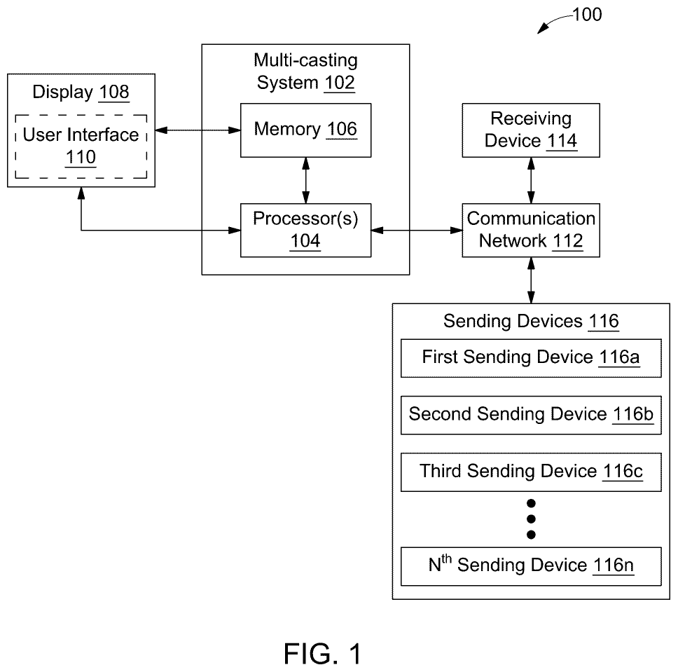

Referring now to FIG. 1, an exemplary system 100 for interactive live-stream projection via a multi-casting system 102 is illustrated, in accordance with some embodiments of the present disclosure. The system 100 may include the multi-casting system 102. Examples of the multi-casting system 102 may include, but are not limited to, a server, a router, an Internet Protocol Television (IPTV) set-top box, a desktop, a laptop, a notebook, a netbook, a tablet, a smartphone, a mobile phone, or any other computing system. The multi-casting system 102 is responsible for processing, managing and delivering the live-stream of a device to users.

In some embodiments, the multi-casting system 102 may include one or more processors 104 and a memory 106. Further, the memory 106 may store processor-executable instructions that, when executed by the one or more processors 104, cause the one or more processors 104 to project the interactive live-stream. Various operations may be performed by the one or more processors 104 to project the interactive live-stream including establishing a wireless connection between devices, rendering options on a User Interface (UI), receiving user inputs, transmitting the live-stream data, and the like.

The memory 106 may also store various data (for example, user device information, connected device details, details of wireless connector that makes connection between the devices, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may include a display 108. The display 108 may further include a User Interface (UI) 110. A user or an administrator may interact with the multi-casting system 102 and vice versa via the user interface 110 accessible via the display 108. By way of an example, the display 108 may be used to display results of analysis performed by the multi-casting device 102 (such as, for displaying connected devices, streaming data, etc.), to the user. By way of another example, the user interface 110 may be used by the user to provide inputs (for example, selection of an option displayed on the UI 110) to the multi-casting system 102. Thus, for example, in some embodiments, the multi-casting system 102 may ingest information provided by the user or the administrator via the user interface 110. Further, for example, in some embodiments, the multi-casting system 102 may render results to the user or the administrator via the user interface 110.

The system 100 may include a receiving device 114 and sending devices 116. As, illustrated in FIG. 1, there may be ‘n’ number of sending devices (for example, a first sending device 116a, a second sending device 116b, a third sending device 116c . . . , and an N^{th} sending device 116n). It should be noted that the first sending device 116a, the second sending device 116b, the third sending device 116c . . . , and the N^{th} sending device 116n are collectively referred to as the sending devices 116. Examples of the receiving device 114 and the sending devices 116 may include, but may not be limited to, a remote server, a digital device, or another computing system. Examples of the receiving device 114 and the sending devices 116 may include, but may not be limited to, a server, a desktop, a laptop, a notebook, a netbook, a tablet, a smartphone, a mobile phone, or any other computing device.

In some embodiments, the multi-casting system 102, the receiving device 114, and the sending devices 116 communicate with each other over a communication network 112 for sending or receiving various data. For example, the multi-casting system 102 may interact with a sending device of the sending devices 116 for receiving the live-stream data, and the receiving device 114 for transmitting the live-stream data. The communication network 112, for example, may be a wireless communication network that may use a Wireless Fidelity (Wi-Fi) Direct technology.

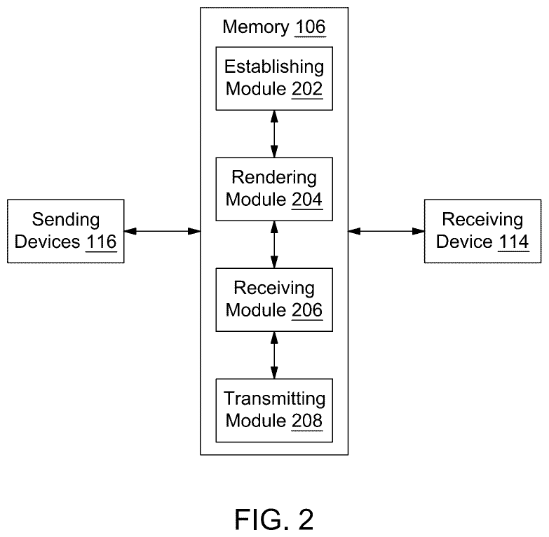

Referring now to FIG. 2, a functional block diagram of various modules within the memory 106 of the multi-casting system 102 configured for interactive live-stream projection is illustrated, in accordance with some embodiments of the present disclosure. FIG. 2 is explained in conjunction with FIG. 1. The memory 106 may include an establishing module 202, a rendering module 204, a receiving module 206, and a transmitting module 208. The memory 106 may store various data and intermediate results generated by the modules 202-208.

The establishing module 202 may be configured for establishing a wireless connection between the receiving device 114 and the sending devices 116. The wireless connection may be established via the Wi-Fi Direct technology. The Wi-Fi Direct technology is a wireless technology that may allow the receiving device 114 and the sending devices 116 to establish direct wireless connection with each other without the need for an internet connection. The Wi-Fi Direct technology operates over same radio frequencies (i.e., 2.4 GHz and 5 GHz bands) as standard Wi-Fi, enabling peer-to-peer wireless communication between the receiving device 114 and the sending devices 116 within a certain range. Further, the establishing module 202 may be communicatively coupled to the rendering module 204.

Once the wireless connection is built, the rendering module 204 may render at least one option corresponding to each of the sending devices 116 on a UI of the receiving device 114 or a UI (such as the UI 110) associated with the receiving device 114. In some embodiments, the rendering module 204 may show information of the connected sending devices 116 and users of the sending devices 116 like their device name, device identity (ID), individual username, activity status, etc., on the UI of the receiving device 114 or the UI associated with the receiving device 114. In one embodiment, the UI of the receiving device 114 may show display screens of the sending devices 116 which may be selected further to see an enlarged view.

By way of an example, consider a scenario where a user has a tablet (i.e., a receiving device) and each of user's family members has a smartphone (i.e., sending devices). Now, they want to establish a connection between the tablet belonging to the user and smartphones belonging to the user's family members, for communication and sharing. In such a case, the establishing module 202 may establish the wireless connection between the tablet and the smartphones through the Wi-Fi Direct technology. Further, when the wireless connection is established, the rendering module 204 may begin to render options on a UI of the tablet or an associated UI. These options correspond to the connected smartphones. For example, on the tablet's UI, one may be able to see icons or names representing each smartphone, such as “Mom's Phone”, “Dad's Phone”, “Sister's Phone”, “A's Phone” and the like. In some embodiments, alongside the options, the rendering module 204 may render relevant information about the connected smartphones and their users. For example, for one of the smartphones, the UI may show information as “Mom's Phone” (i.e., the device name), ID: 12345 (i.e., the device identity), username: Mom123 (i.e., individual username), Active (i.e., activity status). The rendering module 204 may be further communicatively coupled to the receiving module 206.

Further, the receiving module 206 may be configured for receiving a user input. The receiving module 206 receives the user input from a user of the receiving device 114. The user may select an option from the at least one option displayed on the UI of the receiving device 114. For example, the user may select a first option corresponding to the first sending device 116a from the at least one option corresponding to each of the sending devices 116. The user of the receiving device 114 may be provided a control for the selection of a sending device of the sending devices 116 by selecting a corresponding option displayed on the receiving device 114.

Referring to the above explained scenario, the tablet's UI may allow the user of the tablet to interact with the displayed options and information. The user may select a specific smartphone, or a family member based on user's preferences and requirements. For example, the user may tap on “Mom's Phone” to select that smartphone and initiate communication with mother's smartphone. In this case, the user input received by the receiving module 206 may be selection of the “Mom's Phone” option. The receiving module 206 may be further operatively coupled to the transmitting module 208.

The transmitting module 208 may transmit a live-stream data of the first sending device 116a (i.e., the selected sending device) to the receiving device 114 based on the user input. In some embodiments, the transmitting module 208, upon selection of the first option corresponding to the first sending device, may activate the first sending device 116a for multi-casting based on the selected option. In particular, the transmitting module 208 may initiate a live projection of the first sending device screen onto the UI of the receiving device 114. The transmitting module 208 may further render the live-stream data associated with the first sending device screen via a Graphical User Interface (GUI) or UI of the receiving device 114. It should be noted that the at least one option corresponding to each of the sending devices 116 along with the associated live-stream data may be displayed on the GUI or the UI of the receiving device 114. In continuation to the example scenario, further, a live-stream data of the mom's phone may be transmitted to the user's tablet. The UI of the tablet may display the live-stream data as well as other options.

In some embodiments, the receiving module 206 may receive a user input of selection of another option of the at least one option. For example, the receiving module 206 may receive the user input for switching from first sending device 116a to a second sending device 116b by selecting a second option. In that case, the transmitting module 208 may stop transmitting the live-stream data of the first sending device 116a and start transmitting a live-stream data of the second sending device 116b to the receiving device 114 based on the switching. The second sending device 116b may be activated for multi-casting based on the switching to the second option. In particular, the transmitting module 208 may initiate a live projection of the second sending device screen onto the UI of the receiving device 114. The transmitting module 208 may further render the live-stream data associated with the second sending device screen via a Graphical User Interface (GUI) or UI of the receiving device 114. With regards to the example scenario, when the user taps on Dad's Phone option while streaming the live-stream data of Mom's Phone, the transmitting module 208 may shift the live-stream projection from the Mom's Phone to the Dad's Phone.

The multi-casting system 102 may have an associated application. The application may be a computer application and is at least one of a web application, a mobile application, or a web page. The application may run on the sending devices 116 as well as the receiving device 114. The application may have a UI. The user of the receiving device 114 may be able to see options corresponding to the sending devices 116 through the UI of the application running on the receiving device 114. The UI provides control to the user of the receiving device 114 for selecting an option from the options displayed on the UI. The user may provide the user input via the UI. Further, the UI may display the live-stream data of the selected option.

It should be noted that all such aforementioned modules 202-208 may be represented as a single module or a combination of different modules. Further, as will be appreciated by those skilled in the art, each of the modules 202-208 may reside, in whole or in parts, on one device or multiple devices in communication with each other. In some embodiments, each of the modules 202-208 may be implemented as dedicated hardware circuit comprising custom application-specific integrated circuit (ASIC) or gate arrays, off-the-shelf semiconductors such as logic chips, transistors, or other discrete components. Each of the modules 202-208 may also be implemented in a programmable hardware device such as a field programmable gate array (FPGA), programmable array logic, programmable logic device, and so forth. Alternatively, each of the modules 202-208 may be implemented in software for execution by various types of processors (e.g., processors 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for interactive live-stream projection via the multi-casting system 102. For example, the exemplary system 100 and the associated multi-casting system 102 may project interactive live-stream by the processes discussed herein. In particular, as will be appreciated by those of ordinary skill in the art, control logic and/or automated routines for performing the techniques and steps described herein may be implemented by the system 100 and the associated multi-casting system 102 either by hardware, software, or combinations of hardware and software. For example, suitable code may be accessed and executed by the one or more processors on the system 100 and the associated multi-casting system 102 to perform some or all of the techniques described herein. Similarly, application specific integrated circuits (ASICs) configured to perform some or all of the processes described herein may be included in the one or more processors on the system 100 and the associated multi-casting system 102.

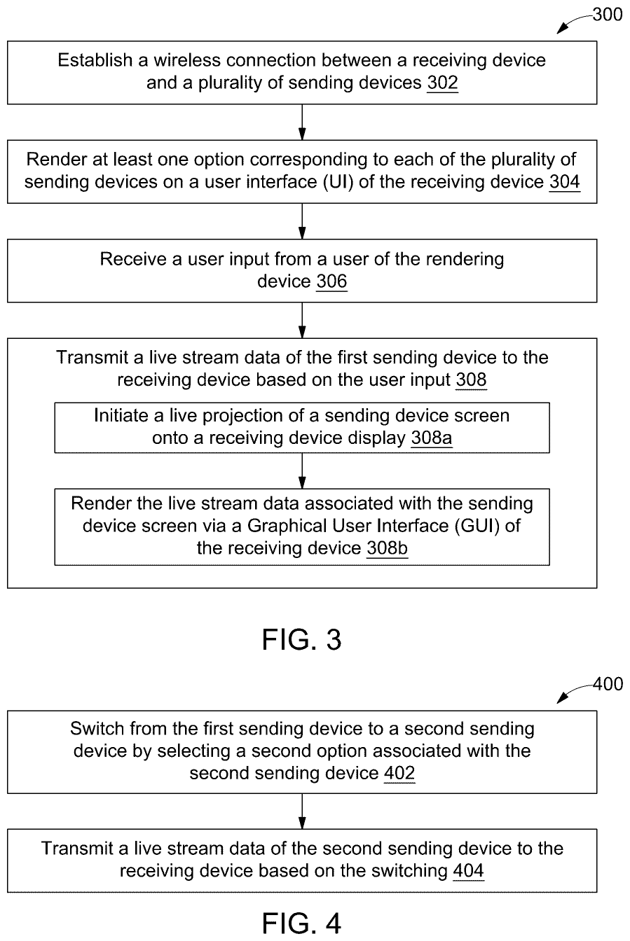

Referring now to FIG. 3, an exemplary process 300 for interactive live-stream projection via a multi-casting system (such as the multi-casting system 102) is depicted via a flowchart 300, in accordance with some embodiments of the present disclosure. The process 300 may be performed by various modules (such as the modules 202-208) of the multi-casting system. FIG. 3 is explained in conjunction with FIGS. 1-2.

At step 302, a wireless connection between a receiving device (such as the receiving device 114) and a plurality of sending devices (such as the sending devices 116) may be established. This step may be performed using an establishing module (such as the establishing module 202). It should be noted that the wireless connection is established via a Wireless Fidelity (Wi-Fi) Direct technology. Examples of the receiving device and the plurality of sending devices may include, but may not be limited to, a remote server, a digital device, or another computing system. Examples of the receiving device and the plurality of sending devices may include, but may not be limited to, a server, a desktop, a laptop, a notebook, a netbook, a tablet, a smartphone, a mobile phone, or any other computing device.

The Wi-Fi Direct technology is a wireless technology that may allow the receiving device and the plurality of sending devices to establish direct wireless connection with each other without the need for an internet connection. The Wi-Fi Direct technology operates over same radio frequencies (i.e., 2.4 GHz and 5 GHz bands) as standard Wi-Fi, enabling peer-to-peer wireless communication between the receiving device and the plurality of sending devices within a certain range.

Upon establishing the connection, at step 304, at least one option corresponding to each of the plurality of sending devices may be rendered on a UI of the receiving device. This step may be performed by a rendering module (same as the rendering module 204). In some embodiments, information of the connected the plurality of sending devices and users of the plurality of sending devices may be shown, like their device name, device identity (ID), individual username, activity status, etc., on the UI of the receiving device.

In response to rendering, at step 306, a user input may be received from a user of the receiving device. This step may be performed using a receiving module (such as the receiving module 206). It should be noted that receiving the user input includes selecting a first option corresponding to a first sending device from the at least one option corresponding to each of the plurality of sending devices. In other words, the user may provide the user input by selecting an option from the at least one option displayed on the UI of the receiving device. For example, the user may select the first option corresponding to the first sending device from the at least one option corresponding to each of the plurality of sending devices. The user of the receiving device may be provided a control for the selection of a sending device of the plurality of sending devices by selecting a corresponding option on the receiving device.

After receiving the user input, at step 308, a live-stream data of the first sending device may be transmitted to the receiving device based on the user input using a transmitting module (such as the transmitting module 208). In some embodiments, upon selection of the first option corresponding to the first sending device, the first sending device may be activated for multi-casting, based on the selected option. Transmitting the live-stream data may further include sub-steps. At step 308a, a live projection of a sending device screen (for example, a first sending device screen) onto a receiving device display may be initiated. Further, at step 308b, the live-stream data associated with the sending device screen (i.e., the first sending device screen) may be rendered via a Graphical User Interface (GUI) or UI of the receiving device. Moreover, the at least one option corresponding to each of the plurality of sending devices along with associated live-stream data may be displayed on the GUI or the UI of the receiving device.

By way of an example, consider a scenario where a user has a tablet (i.e., the receiving device) and each of user's family members has a smartphone (i.e., the plurality of sending devices). Now, they want to establish a connection between the tablet belonging to the user and smartphones belonging to the user's family members, for communication and sharing. In such a case, the wireless connection may be established via the multi-casting system between the tablet and the smartphones through the Wi-Fi Direct technology. Further, when the wireless connection is established, options may be rendered on a UI of the tablet or an associated UI, by the multi-casting system. These options correspond to the connected smartphones. For example, on the tablet's UI, one may be able to see icons or names representing each smartphone, such as “Mom's Phone”, “Dad's Phone”, “sister's Phone”, “A's Phone” and the like. In some embodiments, alongside the options, relevant information about the connected smartphones and their users may also be rendered. For example, for one of the smartphones, the UI may show information as “Mom's Phone” (i.e., the device name), ID: 12345 (i.e., the device identity), username: Mom123 (i.e., individual username), Active (i.e., activity status).

Further, the tablet's UI may allow the user of the tablet to interact with the displayed options and information. The user may select a specific smartphone, or a family member based on user's preferences and requirements. For example, the user may tap on “Mom's Phone” to select that smartphone and initiate communication with mother's smartphone. In this case, the user input received by the multi-casting system may be selection of the “Mom's Phone” option. Thereafter, a live-stream data of the mom's phone may be transmitted to the user's tablet.

Referring now to FIG. 4, an exemplary process 400 for switching between two sending devices is depicted via a flowchart, in accordance with some embodiments of the present disclosure. FIG. 4 is explained in conjunction with FIGS. 1-3. Each step of the process 400 may be implemented via the multi-casting system 102.

With reference to FIG. 3, in order to transmit the live-stream data from the first sending device to the receiving device, the first option has been selected. Now, the user may want to display a live-stream data of a second sending device on the UI of receiving device. In this case, the user must provide an input by tapping on a second option corresponding to the second sending device. At step 402, switching from the first sending device to a second sending device may be performed by selecting the second option associated with the second sending device. It should be noted that the plurality of sending devices may be rendered as options on the receiving device, and the user has a choice to select any of the options. For brevity, the process 400 is explained with respect to the second sending device, however the switching may be between any two of the plurality of the sending devices based on the user input.

For example, the switching may be from the first sending device to a third sending device (for example, the third sending device 116c), the first sending device to an nth sending device (for example, the nth sending device 116n), the third sending device to the first sending device, the second sending device to the third sending device, or the like. Thereafter, at step 404 the live-stream data of the second sending device may be transmitted to the receiving device based on the switching.

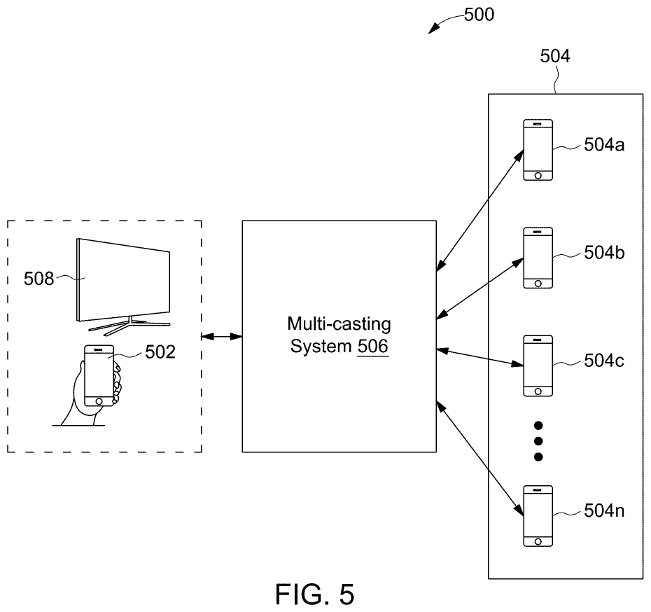

Referring now to FIG. 5, an exemplary scenario of interactive live-stream projection via a multi-casting system is illustrated, in accordance with an exemplary embodiment of the present disclosure. FIG. 5 is explained in conjunction with FIGS. 1-4.

In the exemplary scenario, a smart class 500 is depicted. The class 500 includes a teacher and various students attending a lecture. The teacher has a mobile phone 502 as a receiving device (same as the receiving device 114). Further, the students have mobile phones 504 as sending devices (such as the sending devices 116). For example, a first student may have a mobile phone 504a, a second student may have a mobile phone 504b, a third student may have a mobile phone 504c, . . . , and an nth student may have a mobile phone 504n. The mobile phones 504a, 504b, 504c, . . . , and 504n are collectively referred to as the mobile phones 504.

The teacher may want to discuss assignment of each of the students. For this purpose, a multi-casting system 506 may be used for live-stream projection. Initially, a wireless connection between the mobile phone 502 belonging to the teacher and the mobile phones 504 belonging to the students may established. The wireless connection may be built on a server without the use of the internet through the Wi-Fi Direct technology via the multi-casting system 506. After establishing the wireless connection, the multi-casting system 506 may render options corresponding to each of the mobile phones 504 on a UI of the mobile phone 502. Further, the teacher may provide a user input by selecting a third option associated with a third student's mobile phone 504c, through the UI of the mobile phone 502.

After getting user input from the teacher, the multi-casting system 506 starts transmitting a live-stream data of the mobile phone 508c to the mobile phone 502. The mobile phone 502 provides a control to the teacher to switch anytime from one student's mobile phone to another student's mobile phone. For example, the teacher may provide another input to switch from the mobile phone 504c to mobile phone 504a by tapping on a first option associated with the mobile phone 504a. The multi-casting system 506 may stop transmitting the live-stream data of the mobile phone 504c, and start transmitting a live-stream data of the mobile phone 504a to the mobile phone 502 based on the user input. In some embodiments, the mobile phone 502 may be connected to a big screen 508 or a computing device having the big screen 508, enabling all the students to see the options, the option selection by the teacher, and the live-stream projection of selected mobile phone. In some embodiments, the mobile phone 502 and the mobile phones 504 may run an application associated with the multi-casting system 506, and all the steps of the live-stream projection may be executed through the application.

The students can learn presentation skills and get instant feedback on their work by casting students' screens. Further, learning may be fun, and students may be able to interact with the teacher thoroughly and learn & understand in a better way. In other words, casting a student's screen in a classroom environment offers several valuable benefits. Firstly, it empowers students to develop crucial presentation skills by allowing them to showcase their work to their peers and teachers. This interactive approach not only enhances their ability to communicate effectively but also instills confidence. Moreover, the immediate feedback loop generated through screen casting enables students to identify areas for improvement in real-time, facilitating a more efficient learning process. Overall, the multi-casting system 506 injects an element of fun into learning, fostering active student engagement. It encourages a deeper level of interaction between students and teachers, promoting a richer understanding of the subject matter and ultimately contributing to a more effective and enjoyable learning experience.

The proposed multi-casting system 506 may be designed to facilitate dynamic screen switching among multiple learners at the teacher's request. Learning with the multi-casting system 506 transforms the educational experience into something where the students actively engage, make offerings of their participation and involvement, and collectively work towards a shared educational goal under the guidance of the teacher. In this context, every student actively engages in their own learning activities while simultaneously following the teacher's guidance and demonstrating concepts in real-time. It creates an immersive and participatory learning environment where knowledge flows seamlessly, fostering deeper understanding and engagement among students.

As will be also appreciated, the above-described techniques may take the form of computer or controller-implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

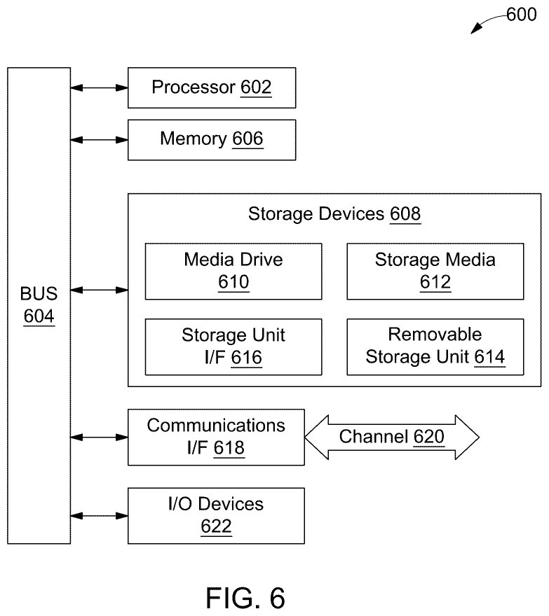

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose multi-casting system as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Various embodiments provide a method and a system for interactive live-stream projection via a multi-casting system. The disclosed method and system may include establishing a wireless connection between a receiving device and a plurality of sending devices. Further, the disclosed method and system may include rendering at least one option corresponding to each of the plurality of sending devices on a user interface (UI) of the receiving device, upon establishing the wireless connection. Moreover, the disclosed method and system may include receiving a user input from a user of the receiving device. Receiving the user input includes selecting an option corresponding to a sending device from the at least one option corresponding to each of the plurality of sending devices, in response to rendering. Thereafter, the disclosed method and system may include transmitting a live-stream data of the first sending device to the receiving device based on the user input.

Thus, the disclosed method and system try to overcome the technical problem of interactive live-stream projection via a multi-casting system. The method and system provide a platform for the user of the receiving device to see the display screen of all the sending devices on the UI of the receiving device. The method and system provide a control to the user of the receiving device to select any of the sending devices' screen. To perform this, all the sending devices and receiving device must establish a wireless connection between them via the multi-casting system and all come under a local area network without using the internet which makes it cost-effective and gives a proper bandwidth to cast the screen without any lag. The user has the control to choose any display screen to see progress of assigned work and can support the other user if the other user is in trouble performing assigned tasks.

Transitioning from traditional static content like slides and videos to dynamic live simulations in the realm of EdTech offers multiple advantages. These include fostering active and experiential learning, enabling real-world context exploration, providing instant feedback, boosting engagement and motivation, facilitating personalized learning paths, encouraging peer collaboration, developing practical skills in a risk-free environment, reducing costs through virtual resources, enhancing accessibility and inclusivity, leveraging open-source content for collaborative customization, harnessing data and analytics for performance insights, preparing learners for real challenges, extending global educational reach, and allowing continuous improvement of educational experiences, ultimately accelerating and enriching learning outcomes across various disciplines and settings.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described the method and system for interactive live-stream projection via a multi-casting system. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for interactive live-stream projection via a multi-casting system, the method comprising:
establishing, via the multi-casting system, a wireless connection between a receiving device and a plurality of sending devices;
upon establishing the wireless connection, rendering, via the multi-casting system, at least one option corresponding to each of the plurality of sending devices on a user interface (UI) of the receiving device;
in response to rendering, receiving, via the multi-casting system, a user input from a user of the receiving device, wherein receiving the user input comprises selecting a first option corresponding to a first sending device from the at least one option corresponding to each of the plurality of sending devices; and
transmitting, via the multi-casting system, a live-stream data of the first sending device to the receiving device based on the user input.

2. The method of claim 1, wherein the wireless connection is established via a Wireless Fidelity (Wi-Fi) Direct technology.

3. The method of claim 1, further comprising:
switching, via the multi-casting system, from the first sending device to a second sending device by selecting a second option associated with the second sending device; and
transmitting, via the multi-casting system, a live-stream data of the second sending device to the receiving device based on the switching.

4. The method of claim 1, further comprising providing a control to the user of the receiving device for selecting a sending device of the plurality of sending devices by selecting a corresponding option.

5. The method of claim 1, wherein selecting the first option corresponding to the first sending device comprises activating the first sending device for multi-casting based on the selected option.

6. The method of claim 1, wherein transmitting the live-stream data comprises:
initiating a live projection of a sending device screen onto a receiving device display; and
rendering the live-stream data associated with the sending device screen via a Graphical User Interface (GUI) of the receiving device.

7. The method of claim 1, wherein the at least one option corresponding to the each of the plurality of sending devices along with an associated live-stream data is displayed on a GUI of the receiving device.

8. A multi-casting system for interactive live-stream projection, the multi-casting system comprising:
a processor; and
a memory communicatively coupled to the processor, wherein the memory stores processor instructions, which when executed by the processor, cause the processor to:
establish a wireless connection between a receiving device and a plurality of sending devices;
render at least one option corresponding to each of the plurality of sending devices on a user interface (UI) of the receiving device, upon establishing the wireless connection;
in response to rendering, receive a user input from a user of the receiving device, wherein receiving the user input comprises selecting a first option corresponding to a first sending device from the at least one option corresponding to each of the plurality of sending devices; and
transmit a live-stream data of the first sending device to the receiving device based on the user input.

9. The multi-casting system of claim 8, wherein the wireless connection is established via a Wireless Fidelity (Wi-Fi) Direct technology.

10. The multi-casting system of claim 8, wherein the processor instructions, on execution, further cause the processor to:
switch from the first sending device to a second sending device by selecting a second option associated with the second sending device; and
transmit a live-stream data of the second sending device to the receiving device based on the switching.

11. The multi-casting system of claim 8, wherein the processor instructions, on execution, further cause the processor to provide a control to the user of the receiving device for selecting a sending device of the plurality of sending devices by selecting a corresponding option.

12. The multi-casting system of claim 8, wherein the processor instructions, on execution, further cause the processor to activate the first sending device for multi-casting based on the selected option upon selecting the first option corresponding to the first sending device.

13. The multi-casting system of claim 8, wherein the processor instructions, on execution, further cause the processor to transmit the live-stream data by:
initiating a live projection of a sending device screen onto a receiving device display; and
rendering the live-stream data associated with the sending device screen via a Graphical User Interface (GUI) of the receiving device.

14. The multi-casting system of claim 8, wherein the at least one option corresponding to the each of the plurality of sending devices along with an associated live-stream data is displayed on a GUI of the receiving device.

15. A non-transitory computer-readable medium storing computer-executable instructions for interactive live-stream projection, the computer-executable instructions configured for:
establishing a wireless connection between a receiving device and a plurality of sending devices;
upon establishing the wireless connection, rendering at least one option corresponding to each of the plurality of sending devices on a user interface (UI) of the receiving device;
in response to rendering, receiving a user input from a user of the receiving device, wherein receiving the user input comprises selecting a first option corresponding to a first sending device from the at least one option corresponding to each of the plurality of sending devices; and
transmitting a live-stream data of the first sending device to the receiving device based on the user input.

16. The non-transitory computer-readable medium of claim 15, wherein the wireless connection is established via a Wireless Fidelity (Wi-Fi) Direct technology.

17. The non-transitory computer-readable medium of claim 15, wherein the computer-executable instructions further configured for:
switching from the first sending device to a second sending device by selecting a second option associated with the second sending device; and
transmitting a live-stream data of the second sending device to the receiving device based on the switching.

18. The non-transitory computer-readable medium of claim 15, wherein the computer-executable instructions further configured for providing a control to the user of the receiving device for selecting a sending device of the plurality of sending devices by selecting a corresponding option.

19. The non-transitory computer-readable medium of claim 15, wherein the computer-executable instructions further configured for activating the first sending device for multi-casting based on the selected option.

20. The non-transitory computer-readable medium of claim 15, wherein the computer-executable instructions configured for transmitting the live-stream data by:
initiating a live projection of a sending device screen onto a receiving device display; and
rendering the live-stream data associated with the sending device screen via a Graphical User Interface (GUI) of the receiving device.
